(19) United States
(12) Patent Application Publication
(10) Pub. No.: US 2025/0314930 A1
(43) Pub. Date: Oct. 9, 2025

(54) HIGH RESOLUTION VIRTUAL REALITY LCD DISPLAY

(71) Applicant: Meta Platforms Technologies, LLC, Menlo Park, CA (US)

(72) Inventors: Jie XIANG, San Jose, CA (US); Yongmin PARK, Sammamish, WA (US); Alexander KLEMENT, Kenmore, WA (US); Agnes LEE, Da'an (TW); Linghui RAO, Redmond, WA (US); Cagdas VAREL, Seattle, WA (US); Hsin-Ying CHIU, San Jose, CA (US); Firmansyah SULEM, San Jose, CA (US)

(21) Appl. No.: 18/896,639

(22) Filed: Sep. 25, 2024

Related U.S. Application Data
(60) Provisional application No. 63/585,597, filed on Sep. 26, 2023.

(51) Int. Cl. G02F 1/1339; G02B 27/01

(52) U.S. Cl. CPC G02F 1/1339; G02B 27/0172

(57) ABSTRACT

A liquid crystal display (LCD) of a near-eye display includes a first substrate, a second substrate, a plurality of photo spacers formed on the second substrate, a plurality of sub-spacers formed on the first substrate, and a liquid crystal material in regions between the first substrate and the second substrate. Each sub-spacer of the plurality of sub-spacers is configured to support a corresponding photo spacer of the plurality of photo spacers. A resolution of the LCD is greater than 800 pixels per inch. Each photo spacer of the plurality of photo spacers has a smaller lateral size and a larger height than the corresponding sub-spacer of the plurality of photo spacers.

### CROSS-REFERENCE TO RELATED APPLICATION

This application claims the benefit of and priority to U.S. Provisional Application No. 63/585,597, filed Sep. 26, 2023, entitled “HIGH RESOLUTION VIRTUAL REALITY LCD DISPLAY,” which is hereby incorporated by reference in its entirety for all purposes.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications.

### SUMMARY

This disclosure relates generally to liquid crystal displays (LCDs) for near-eye display. More specifically, and without limitation, disclosed herein are techniques for improving visual quality and user experience in high resolution (e.g., high pixel per inch (PPI)) virtual reality (VR) HMD, such as reducing photo spacer (PS) mura, screen door effect, ghosting, and latency, and increasing the color gamut. Various inventive embodiments are described herein, including devices, systems, methods, structures, materials, processes, and the like.

According to certain embodiments, a liquid crystal display (LCD) of a near-eye display may include a first substrate, a second substrate, a plurality of photo spacers formed on the second substrate, a plurality of sub-spacers formed on the first substrate, and a liquid crystal material in regions between the first substrate and the second substrate. Each sub-spacer of the plurality of sub-spacers is configured to support a corresponding photo spacer of the plurality of photo spacers. A resolution of the LCD is greater than 800 pixels per inch (e.g., about 1200 pixels per inch or higher). Each photo spacer of the plurality of photo spacers may have a smaller lateral size and a larger height than the corresponding sub-spacer of the plurality of photo spacers.

In some embodiments, a screen-door effect of the LCD may be reduced by increasing a pixel per inch (PPI) of the LCD, using more spacers having smaller sizes, or a combination thereof. In some embodiments, display ghosting of the LCD may be reduced by: reducing panel scan time; reducing an on-time of a backlight unit of the LCD; delaying the on-time of the backlight unit such that the on-time of the backlight unit for an image frame and panel scan time of the next image frame at least partially overlap; reducing a gap between the first substrate and the second substrate; using a liquid crystal material with a low viscosity and a high birefringence; increasing a Mobile Industry Processor Interface (MIPI) rate of the LCD; or a combination thereof. In some embodiments, a spectral radiance of the LCD may be selected based on a spectral transmittance curve of display optics of the near-eye display such that the near-eye display can achieve a target color gamut (e.g., the sRGB color gamut). In some embodiments, a motion to photon latency of a near-eye display that includes the LCD may be reduced by: increasing a motion sensor sampling rate of the near-eye display; improving a motion prediction accuracy of the near-eye display; increasing a refresh rate of the LCD; adjusting backlight timing based on temperature; or a combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical system with a non-pupil forming configuration for a near-eye display device according to certain embodiments.

FIG. 6 illustrates an example of a liquid crystal display (LCD) panel.

FIG. 7 illustrates an example of a layer stack of an LCD panel.

FIGS. 8A-8B illustrate examples of photo spacers and sub-spacers in LCD cells.

FIG. 9A illustrates an example of an LCD cell with large photo spacers and sub-spacers.

FIG. 9B illustrates an example of lateral displacement between a photo spacer and a sub-spacer in the LCD cell of FIG. 9A.

FIG. 9C illustrates an example of an LCD cell with small photo spacers and sub-spacers.

FIG. 9D illustrates an example of lateral displacement between a photo spacer and a sub-spacer in the LCD cell of FIG. 9C.

FIG. 10A illustrates an example of an LCD panel in a normal mode.

FIG. 10B illustrates an example of a soft failure mode of an LCD panel due to photo spacer (PS) mura caused by shear stress.

FIG. 11A illustrates an example of a hard failure mode of an LCD panel due to photo spacer (PS) mura caused by shear stress.

FIG. 11B illustrates an example of light leakage due to PS mura.

FIG. 11C illustrates examples of bright dots caused by PS mura in an LCD panel.

FIG. 11D illustrates an example of an LCD panel according to certain embodiments.

FIG. 12A illustrates an example of pixel design in an example of an LCD panel.

FIG. 12B includes an example of a microscopic image showing the screen-door effect (SDE) of the LCD of FIG. 12A.

FIG. 12C illustrates an example of pixel design in an example of an LCD panel with reduced SDE.

FIG. 12D illustrates an example of a photomask showing pixel design of the LCD panel of FIG. 12C.

FIG. 12E illustrates an example of a microscopic image showing the reduced screen-door effect of the LCD panel of FIG. 12C.

FIG. 13 illustrates an example of display ghosting in an LCD panel.

FIG. 14 illustrates an example of a timing diagram of an image frame of an LCD.

FIG. 15 illustrates an example of a radiance spectrum of an LCD panel of a VR HMD.

FIG. 16 illustrates examples of the spectral transmittance curve of display optics (e.g., lenses) of an VR HMD.

FIG. 17 illustrates an example of a radiance spectrum of an VR HMD.

FIG. 18 illustrates an example of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to liquid crystal displays (LCDs) for near-eye display. More specifically, and without limitation, disclosed herein are techniques for improving visual quality and user experience in high resolution (e.g., high pixel per inch (PPI)) virtual reality (VR) HMD, such as reducing photo spacer (PS) mura, screen door effect, ghosting, and latency, and improving the color gamut. Various inventive embodiments are described herein, including devices, systems, methods, structures, materials, processes, and the like.

Augmented reality (AR) and virtual reality (VR) applications may use near-eye displays (e.g., head-mounted displays) to present images to users. A near-eye display system may include an image source (e.g., a display panel) for generating image frames, and display optics for projecting the image frames to the user's eyes. In near-eye displays, the display panels or image sources may be implemented using, for example, liquid crystal display (LCD), organic light emitting diode (OLED) display, micro-OLED display, inorganic light emitting diode (ILED) display, quantum-dot light emitting diode (QLED) display, micro-light emitting diode (micro-LED) display, active-matrix OLED display (AMOLED), transparent OLED display (TOLED), and the like. It is generally desirable that the image source or the display panel of a near-eye display system has a higher resolution, a large field of view (FOV), a large color gamut, a large size, and better image quality, to improve the immersive experience of using the near-eye display system. For a battery-powered near-eye display system, it may also be desirable that the system has a higher power efficiency to improve the battery life of the system.

The FOV of a display system is the angular range over which an image may be projected in the near or far field. The FOV of a display system is generally measured in degrees, and the resolution over the FOV is generally measured in pixels per degree (PPD). The FOV of a display system may be linearly proportional to the size of the image source (e.g., the display panel), and may be inversely proportional to the focal length of the display optics (e.g., a collimation lens or lens assembly). The size of the image source and the optical power of the display optics may be balanced in order to achieve a good modulation transfer function (MTF) and reduced size/weight/cost. For example, for a smaller display panel, the field of view may be increased by bringing the image source closer, but the image source may need to have a higher PPD, and the aberrations of the display optics at the periphery may limit the effective field of view. In addition, to achieve a high PPD, micro displays with ultra-high pixels per inch (PPI) may be used. There may be many technological challenges and cost issues associated with producing high-PPI display panels with large sizes to cover wider FOVs. As such, the FOVs of current AR/VR/MR systems may be limited, which may adversely affect the user experience.

Many consumer virtual reality (VR) near-eye display systems use LCD panels to generate the displayed images. LCD panels for VR applications typically operate in a transmissive mode, where light may be modulated while being transmitted by the LCD panels. For example, a transmissive LCD panel may include a backlight unit (BLU) and a liquid crystal (LC) panel that may modulate and filter light from the BLU at individual pixels. The LC panel may include a liquid crystal cell sandwiched by a bottom (or back) substrate and a top (or front) substrate. In some implementations, the bottom substrate may include thin-film transistor (TFT) circuits formed on a glass substrate for controlling the liquid crystal cell, whereas the top substrate may include a common electrode and an array of color filters formed thereon. In some implementations, the bottom substrate may include both TFT circuits and an array of color filters formed on a glass substrate (referred to as color filter on array (COA)), whereas the top substrate may include a common electrode and a black matrix formed thereon. In some implementations, pixel electrodes and the common electrode may both be formed on the bottom substrate, for example, in fringe field switching (FFS) mode liquid crystal display, whereas the top substrate may include a black matrix (BM) and an overcoat layer formed thereon. Spacers may be used to separate the bottom substrate and the top substrate and create a gap between the two substrates such that a liquid crystal material may be filled in the gap. For example, the bottom substrate may include sub-spacers (SS) formed thereon, and the top substrate may include photo spacers (PS) formed thereon. When the top substrate and the bottom substrate are assembled to form an LCD cell or LCD panel, the photo spacers may land on the corresponding sub-spacers to achieve the desired separation between the top substrate and the bottom substrate.

LCD panels may offer many advantages over other display technologies, such as lower cost, longer lifetime, higher energy efficiencies, larger sizes, and the like. State-of-art liquid crystal display technologies, low-temperature polycrystalline oxide (LTPO) backplane, and the like have been developed to improve the performance of LCD panel. But there are still many challenges associated with LCD panels, such as lower resolution, longer response time, PS mura, screen-door effect (SDE), ghost images, longer latency, smaller color gamut, and the like.

For example, high-resolution transmissive LC panels (e.g., with a PPI greater than about 600 or higher, such as about 1400 or higher) may have low panel transmission and thus low power efficiency due to, for example, the reduced aperture ratio (e.g., the pixel active area over the total pixel area) of each pixel. In order to have higher display brightness while not significantly increasing the system power, smaller PS and BM may be used in transmission display. When an LCD cell is bent, pressed, or otherwise deformed, the substrate deflection or deformation may cause a shift of the photo spacers with respect to the sub-spacers, such that some photo spacers may no longer sit on the corresponding sub-spacers. When the shift is larger than the size of a photo spacer or a sub-spacer, the photo spacer may touch the bottom substrate, and may cause damages to surrounding regions or otherwise affect the light transmission/modulation in the surrounding regions. As such, light transmission or illuminance in some areas of the LCD cell may be different or anomalous from the neighboring areas, which may be referred to as mura (blemish in Japanese) failures (or defects) or patterned brightness non-uniformity (BNU). Mura defects may have irregular shapes and may result in low contrast or otherwise affect the quality of the displayed images. In LCD panels with higher resolution, the pixels may be small and the spacers may be small as well. Therefore, a small displacement may cause the disengagement of the photo spacers and the sub-spacers and cause mura defects. As such, mura defects may become more severe in LCD panels with higher resolution.

According to certain embodiments, the SS size and light shield (LS) size of an LCD panel can be increased, the PS size can be reduced, the PS/SS height ratio can be adjusted (e.g., to have a lower SS height), the process can be improved to make PS and SS flat, and the thickness of the color filter glass and/or TFT glass can be adjusted, to improve PS mura margin and achieve a mechanically robust display.

The screen-door effect (SDE) is a visual artifact of displays, where the lines separating pixels/subpixels may become visible in the displayed images. In transmissive LCDs, pixel circuits, bus lines, and other opaque structures may compete for space with the transmissive area where light can pass through (the pixel active area). As the pixel density increases, the pixel circuits may take more and more space, leaving smaller and smaller active areas, such that the SDE may become more severe. In LCD displays for VR applications, the SDE may be observable due to high magnification of the lens. According to certain embodiments, in addition to increase the display resolution (PPI), the pixel/cell design may be improved to mitigate the SDE.

In VR head-mounted displays (HMDs), color perception may have a significant impact on user experience because users may be immersed in a dark environment. The color performance of VR HMDs may depend on the display spectra and lens spectra. According to certain embodiments, the color gamut of an VR HMD may be improved by considering both the lens spectra and the display spectra, for example, by considering the lens spectra when designing the color filters and pixels.

Display ghosting is a visually perceivable phenomenon that might appear as double images when users move their heads fast or when users view fast-moving objects without head movements. Display ghosting may occur when the BLU pulse is on while the liquid crystal is still settling and not fully switched, causing smeared ghosting image besides the original picture. According to certain embodiments, the display ghosting may be reduced by reducing the cell gap and/or using liquid crystal materials with low viscosity and high birefringence to improve the liquid crystal response time, reducing display line scanning time, reducing BLU on width, delaying BLU on time (e.g., at least partially into the line scanning time of the next frame) to give more time for liquid crystal to settle during each frame, or a combination thereof.

Motion to photon latency (M2PL) is the lag between a user making a head movement and the movement being fully reflected on the display. Low M2PL can improve the immersive experience of the user (to make user feel that they are present in the virtual world). High M2PL may cause poor virtual reality experience, causing motion sickness and nausea. M2PL may be reduced by, for example, increasing motion sensor sampling rate, improving motion prediction accuracy, increasing display refresh rate, and the like. According to certain embodiments, the motion to photon latency for VR LCD display may be reduced using, for example, temperature dependent backlight timing, increased display MIPI rate, display scaling, or a combination thereof.

The VR LCD displays described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

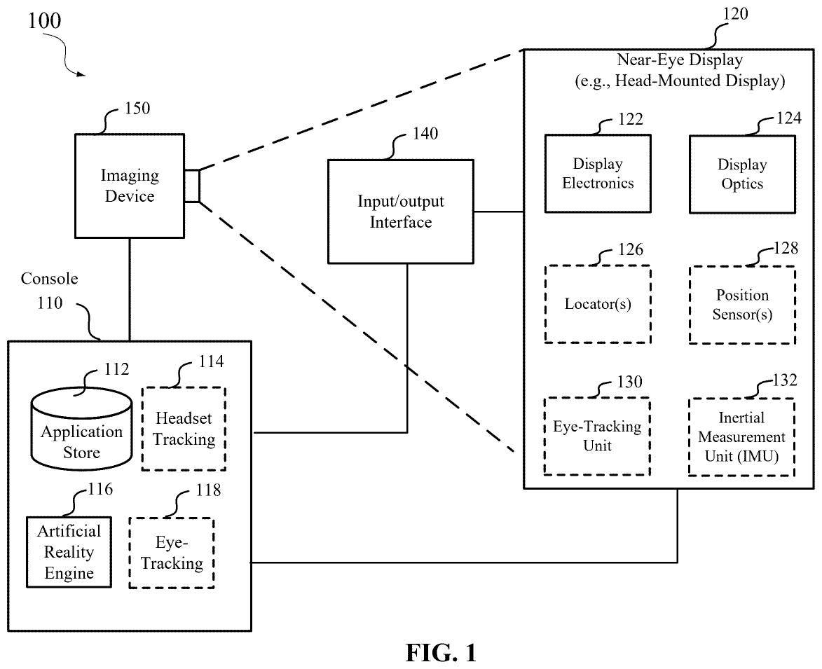

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

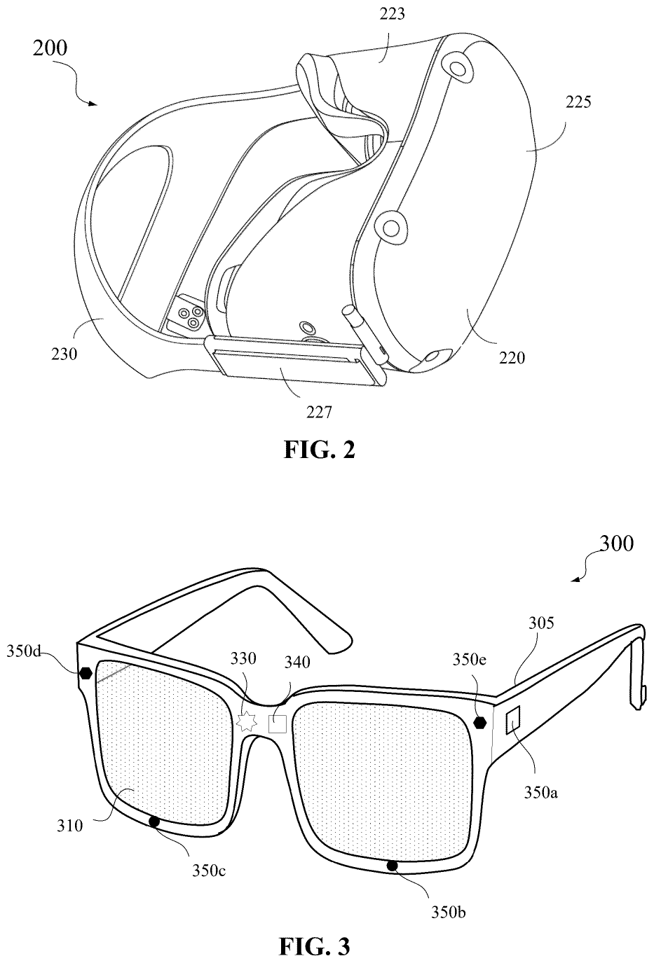

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)).

In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

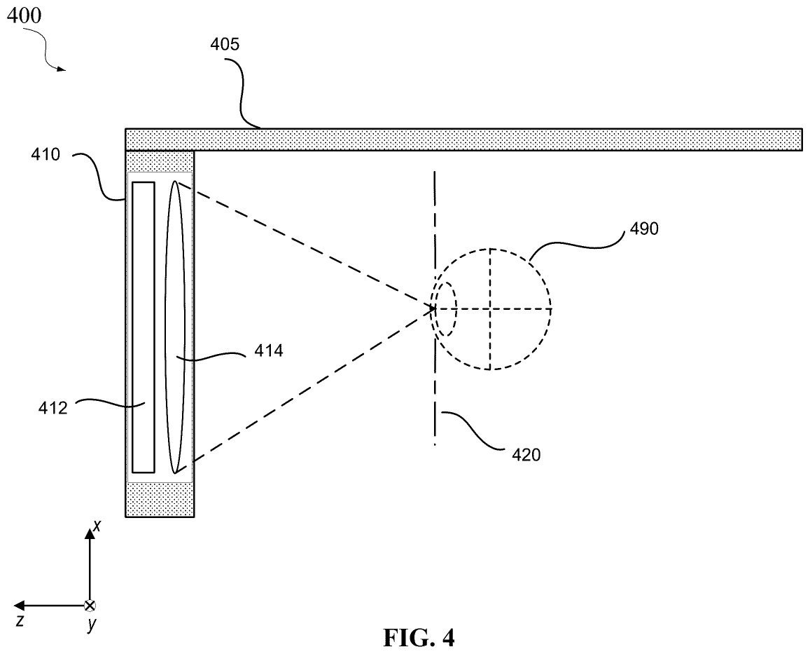

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

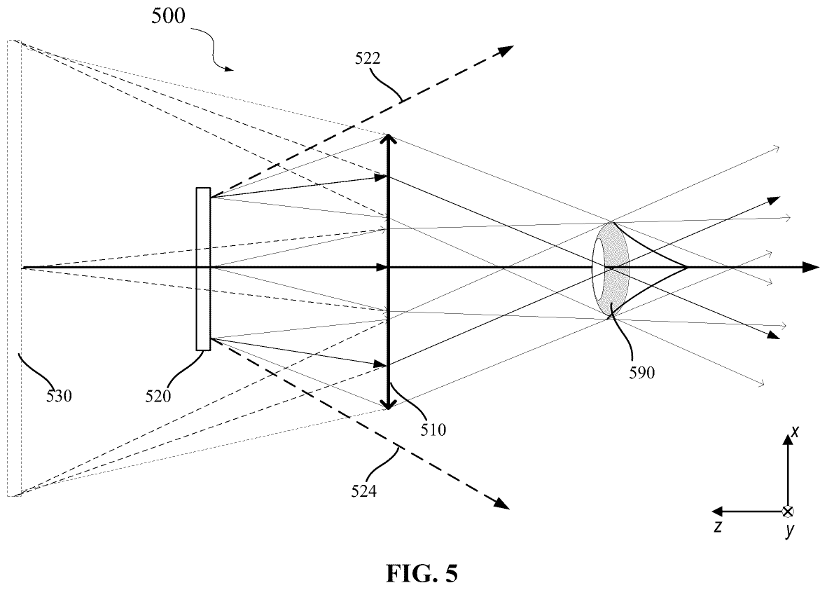

FIG. 5 illustrates an example of an optical system 500 with a non-pupil forming configuration for a near-eye display device according to certain embodiments. Optical system 500 may be an example of near-eye display 400, and may include display optics 510 and an image source 520 (e.g., a display panel). Display optics 510 may function as a magnifier. FIG. 5 shows that image source 520 is in front of display optics 510. In some other embodiments, image source 520 may be located outside of the field of view of the user's eye 590. For example, one or more deflectors or directional couplers may be used to deflect light from an image source to make the image source appear to be at the location of image source 520 shown in FIG. 5. Image source 520 may be an example of display 412 described above. For example, image source 520 may include a two-dimensional array of light emitters, such as semiconductor micro-LEDs or micro-OLEDs. The dimensions and pitches of the light emitters in image source 520 may be small. For example, each light emitter may have a diameter less than 2 μm (e.g., about 1.2 μm) and the pitch may be less than 2 μm (e.g., about 1.5 μm). As such, the number of light emitters in image source 520 can be equal to or greater than the number of pixels in a display image, such as 960×720, 1280×720, 1440×1080, 1920×1080, 2160×1080, 2560×1080, or even more pixels. Thus, a display image may be generated simultaneously by image source 520.

Light from an area (e.g., a pixel or a light emitter) of image source 520 may be directed to a user's eye 590 by display optics 510. Light directed by display optics 510 may form virtual images on an image plane 530. The location of image plane 530 may be determined based on the location of image source 520 and the focal length of display optics 510. A user's eye 590 may form a real image on the retina of user's eye 590 using light directed by display optics 510. In this way, objects at different spatial locations on image source 520 may appear to be objects on an image plane far away from user's eye 590 at different viewing angles. Image source 520 may have a size larger or smaller than the size (e.g., aperture) of display optics 510. Some light emitted from image source 520 with large emission angles (as shown by light rays 522 and 524) may not be collected and directed to user's eye 590 by display optics 510, and may become stray light.

The display panels or image sources described above (e.g., display 412 or image source 520) may be implemented using, for example, a liquid crystal display (LCD), an organic light emitting diode (OLED) display, a micro-OLED display, an inorganic light emitting diode (ILED) display, a micro-light emitting diode (micro-LED) display, an active-matrix OLED display (AMOLED), a transparent OLED display (TOLED), or some other displays. In a near-eye display system, it is generally desirable that the image source or the display panel has a higher resolution and a large size, such that the near-eye display system may have a large field of view (FOV) and better image quality to, for example, improve the immersive experience of using the near-eye display system. The FOV of a display system is the angular range over which an image may be projected in the near or far field. The FOV of a display system is generally measured in degrees, and the resolution over the FOV is generally measured in pixels per degree (PPD). The FOV of a display system may be linearly proportional to the size of the image source (e.g., the display panel), and may be inversely proportional to the focal length of the display optics (e.g., a collimation lens or lens assembly). A balance between the size of the image source and the optical power of the display optics may be desired in order to achieve a good modulation transfer function (MTF) and reduced size/weight/cost. The field of view may be increased by bringing the image source closer, but the image source may need to have higher PPD, and the aberrations of the display optics at the periphery may limit the effective field of view. To achieve a high PPD, micro displays with ultra-high pixels per inch (PPI) may be used. There may be many technological challenges and cost issues associated with making high-PPI display panels, such as high resolution LCD panels.

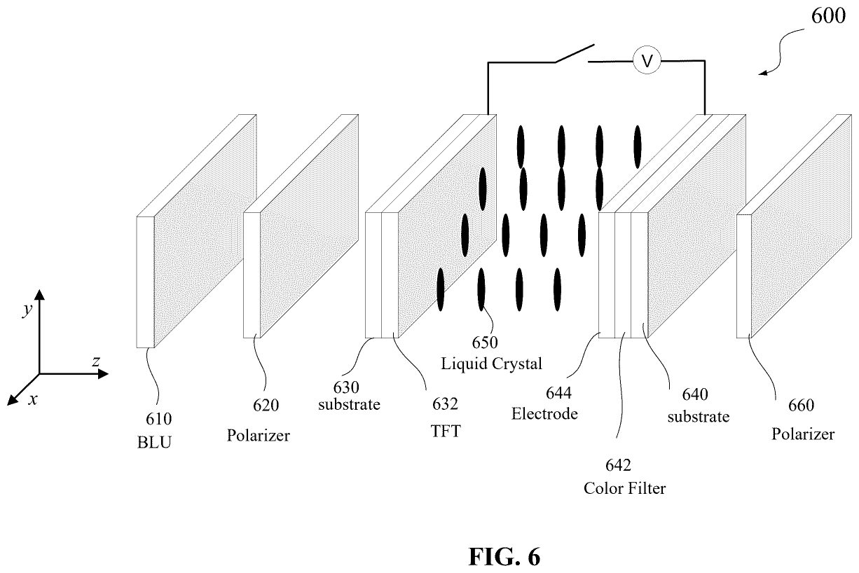

FIG. 6 illustrates an example of an LCD panel 600. As illustrated, LCD panel 600 may include a backlight unit (BLU) 610 configured to emit illumination light, a first polarizer 620 configured to control the type of light that can pass through (e.g., based on the polarization state of the light), an LCD cell that may modulate (e.g., the phase or polarization state of) the incident light, and a second polarizer 660 for control the type of light that can pass through (e.g., based on the polarization state of the light). In some embodiments, BLU 610 may include a light source (e.g., a cold-cathode fluorescent lamp) configured to emit white light. In some embodiments, BLU 610 may include blue light-emitting LEDs, a light guide plate, and a quantum dot enhancement film that includes quantum dots for converting some blue light to red light and green light.

In the illustrated example, the LCD cell may include a first substrate 630 (e.g., a glass substrate or another transparent dielectric substrate) including a thin-film transistor (TFT) array 632 formed thereon. TFT array 632 may include an array of transistors for controlling the intensity of each pixel (e.g., by controlling the orientations of the liquid crystal molecules in a liquid crystal layer, thereby controlling the rotation angle of the polarization direction of the incident light). The LCD cell may also include a second substrate 640 with a common electrode 644 and a color filter (CF)/black-matrix (BM) array 642 formed thereon. One or more liquid crystal layers 650 may be sandwiched by first substrate 630 and second substrate 640.

In some other implementations, first substrate 630 may include both TFT array 632 and color filters formed on TFT array 632 to form a color filter on array (COA) structure, whereas the top substrate may include a common electrode and a black matrix formed on another glass substrate. The COA structure may enable a simplified process, improved aperture ratio, and reduced production cost. In some implementations, the LCD cell may be a fringe field switching (FFS) mode LCD cell, where the pixel electrodes and the common electrode may both be formed on the bottom substrate, and the top substate may include a black matrix and an overcoat layer formed thereon.

Light emitted by BLU 610 (e.g., white light or blue light) may be polarized by first polarizer 620 (e.g., a linear polarizer with a polarizing axis in a first direction). The polarized light may pass through an array of apertures between the TFTs in TFT array 632. The polarized light may be modulated by the one or more liquid crystal layers 650 to change the polarization state (e.g., the polarization direction) according to the voltage signal applied to each region of the one or more liquid crystal layers 650. CF/BM array 642 may include red, green, and blue color filters, where each color filter may allow light of one color to pass through. Light passing through each color filter may become a subpixel of a color image pixel that may include three subpixels, and may be filtered by second polarizer 660 such that the change in the polarization state may be converted into a change in the light intensity or brightness. For example, second polarizer 660 may include a linear polarizer with a polarizing axis in a second direction that may be the same as or different from the first direction.

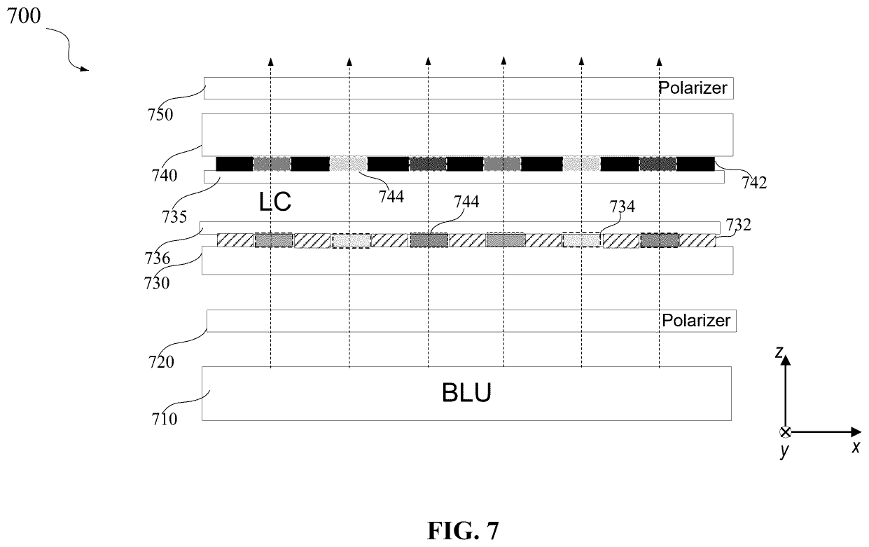

FIG. 7 illustrates an example of a layer stack of an LCD panel 700. LCD panel 700 may be an example of LCD panel 600. In the illustrated example, LCD panel 700 may include a BLU 710, a first polarizer 720, a TFT array 730 including a black-mask layer 732 and an array of apertures 734, a common electrode layer 735, a CF/BM array 740 including a black-matrix layer 742 and optionally an array of color filter elements 744 in black-matrix layer 742, and a second polarizer 750. BLU 710 may be similar to BLU 610 described above. Black-mask layer 732 may include TFT circuits (e.g., TFTs, gate electrodes, source electrodes, etc.) for controlling liquid crystal molecules filled between TFT array 730 and common electrode layer 735. Common electrode layer 735 may include a transparent conductive oxide (TCO), such as indium tin oxide (ITO). Color filter elements 744 may include red, green, and blue color filters. Centers of color filter elements 744 may align with corresponding centers of apertures 734 on TFT array 730, such that light from BLU 710 and first polarizer 720 may pass through apertures 734 and color filter elements 744. Second polarizer 750 may include a linear polarizer with a polarizing axis in a direction that is different from or same as the direction of the polarizing axis of first polarizer 720. For example, the direction of the polarizing axis of first polarizer 720 may be orthogonal to the direction of the polarizing axis of second polarizer 750. First polarizer 720 and second polarizer 750 may be used in combination to convert the change in the polarization state (e.g., polarization direction) by the liquid crystal layer to change in the light intensity so as to display images to user's eyes.

As described above with respect to FIG. 6, in some implementations, instead of forming color filters 744 on a separate substrate, color filters 744 may be formed on TFT array 730 to form a COA structure. In some implementations, the LCD cell may be an FFS mode LCD cell, where both the pixel electrodes and the common electrode may be formed on the bottom substrate with TFT array 730. In other implementations, the TFT array, the color filters, the black matrix, and the electrodes may be arranged in other manners on the two substates that sandwich the liquid crystal material.

Even though not shown in FIG. 7, spacers (e.g., plastic spacers) may be used between TFT array 730 and common electrode layer 735 to separate TFT array 730 and common electrode layer 735 so that liquid crystal materials may be filled between TFT array 730 and common electrode layer 735 to modulate incident light. For example, TFT array 730 may include sub-spacers formed thereon (e.g., on top of source electrodes), and CF/BM array 740 (or common electrode layer 735) may include photo spacers formed thereon. When TFT array 730 and CF/BM array 740 are assembled to form an LCD cell, photo spacers may sit on corresponding sub-spacers to achieve the desired separation between TFT array 730 and CF/BM array 740 (or common electrode layer 735).

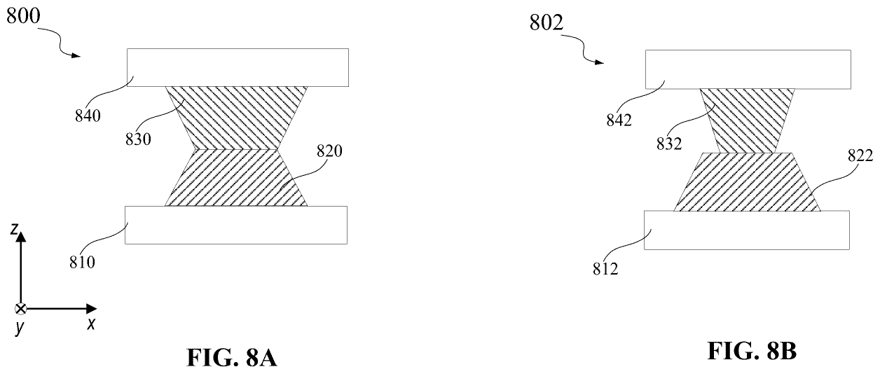

FIGS. 8A-8B illustrate examples of photo spacers and sub-spacers in LCD cells. In the example shown in FIG. 8A, an LCD cell 800 may include a bottom substrate 810 and a top substrate 840 that are separated by sub-spacers 820 and photo spacers 830. Bottom substrate 810 may include, for example, a glass substrate with TFT circuits (and black mask) formed thereon, where the TFT circuits may include thin-film transistors, pixel electrodes (e.g., source electrodes and gate electrodes), electrical interconnects, and other circuits. Top substrate 840 may include, for example, a glass substrate with a black matrix, color filters, and a common electrode layer formed thereon, as described above with respect to, for example, FIGS. 6 and 7. Sub-spacers 820 and photo spacers 830 may include, for example, an organic material (e.g., a plastic material) or another non-conductive material with a certain stiffness, or a metal with a non-conductive coating. Photo spacers 830 may sit on top of sub-spacers 820 when properly assembled. The heights of photo spacers 830 and sub-spacers 820 may be selected to achieve a desired distance between top substrate 840 and bottom substrate 810. In the example shown in FIG. 8A, the top surface of a sub-spacer 820 and the bottom surface of a corresponding photo spacer 830 may have about the same size and may be aligned properly.

In the example shown in FIG. 8B, an LCD cell 802 may include a bottom substrate 812 and a top substrate 842 separated by sub-spacers 822 and photo spacers 832. Bottom substrate 812 may be similar to bottom substrate 810, and top substrate 842 may be similar to top substrate 840. A sub-spacer 822 may have a lateral size larger than the lateral size of a corresponding photo spacer 832, and thus photo spacer 832 may remain sitting on top of sub-spacer 822 even if there is a small amount of lateral displacement or misalignment between bottom substrate 812 and top substrate 842.

When an LCD panel is bent, pressed, or otherwise deformed, the substrate deflection or deformation may cause the displacement of the photo spacers with respect to the sub-spacers, such that some photo spacers may no longer sit on the corresponding sub-spacers. When the displacement is larger than the size of a photo spacer or a sub-spacer, the photo spacer may touch the bottom substrate instead of the sub-spacer, and thus may cause damages to surrounding regions or otherwise affect the light transmission/modulation in the surrounding regions. Therefore, light transmission or illuminance in some areas may be different or anomalous from the neighboring areas, which may be referred to as mura defects. In LCD panels with higher resolution, the pixels and the pitch of the array of pixels may be small, and thus the spacers may be small as well. Therefore, a small displacement may cause the disengagement of the photo spacers and the sub-spacer. As such, mura defects may become more severe in LCD panels with higher resolution.

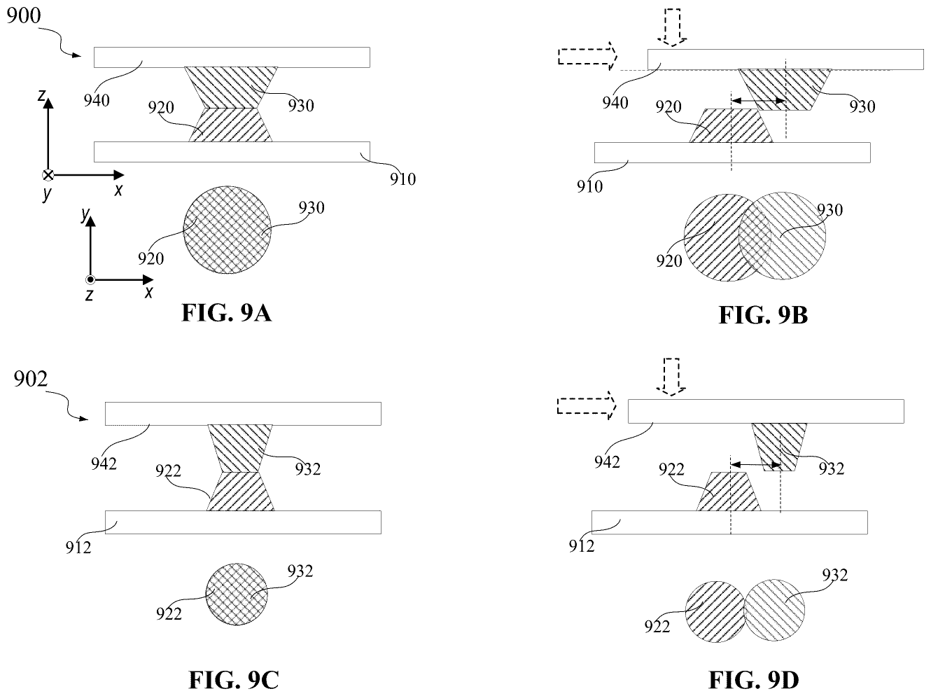

FIG. 9A illustrates an example of an LCD cell 900 with large photo spacers and sub-spacers. As LCD cells 800, 802, and 804, LCD cell 900 may include a bottom substrate 910 and a top substrate 940 that are separated by sub-spacers 920 and photo spacers 930. Bottom substrate 910 may be similar to bottom substrate 810, and top substrate 940 may be similar to top substrate 840. LCD cell 900 may have a lower resolution and a larger pixel pitch. Therefore, sub-spacers 920 and photo spacers 930 can be made larger without impacting the light transmission. When bottom substrate 910 and top substrate 940 are properly aligned (e.g., no force to bend or shift top substrate 940 with respect to bottom substrate 910), the top surface of a sub-spacer 920 and the bottom surface of a corresponding photo spacer 930 may be aligned properly.

FIG. 9B illustrates an example of lateral displacement between a photo spacer 930 and a sub-spacer 920 in LCD cell 900 of FIG. 9A due to, for example, glass deflection. The displacement may be caused by, for example, a force applied to top substrate 940 and/or bottom substrate 910 that may cause the lateral displacement or bending of top substrate 940. Since sub-spacers 920 and photo spacers 930 may be relatively large, photo spacer 930 may still be on top of and in contact with sub-spacer 920 when the lateral displacement is small.

FIG. 9C illustrates an example of an LCD cell 902 with smaller photo spacers 932 and sub-spacers 922. LCD cell 902 may include a bottom substrate 912 and a top substrate 942 that are separated by sub-spacers 922 and photo spacers 932. Bottom substrate 912 may be similar to bottom substrate 810, and top substrate 942 may be similar to top substrate 840. LCD cell 902 may have a higher resolution and thus a smaller pixel pitch. Therefore, sub-spacers 922 and photo spacers 932 may be smaller than sub-spacers 920 and photo spacers 930, respectively. When bottom substrate 912 and top substrate 942 are properly aligned (e.g., no force to bend or shift top substrate 942 with respect to bottom substrate 912), the top surface of a sub-spacer 922 and the bottom surface of a corresponding photo spacer 932 may be aligned properly.

FIG. 9D illustrates an example of lateral displacement between a photo spacer 932 and a sub-spacer 922 in LCD cell 902 of FIG. 9C due to, for example, glass deflection. The lateral displacement may be caused by, for example, a force applied to top substrate 942 and/or bottom substrate 912 that may cause the lateral displacement or bending of top substrate 942. Since sub-spacers 922 and photo spacers 932 may be relatively small, a photo spacer 930 may disengage with the corresponding sub-spacer and may touch bottom substrate 912 to cause mura failures even if the lateral displacement is small.

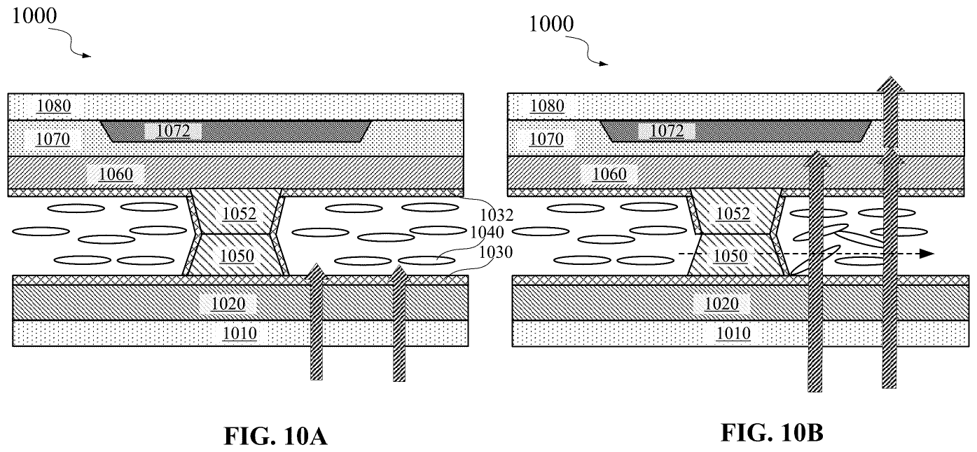

FIG. 10A illustrates an example of an LCD panel 1000 in a normal mode. In the illustrated example, LCD panel 1000 may include a first substrate 1010, a driver array 1020, alignment layers 1030 and 1032, sub-spacers 1050, photo spacers 1052, a liquid crystal layer 1040, a protective layer 1060, color filters 1070, a black matrix 1072, and a second substrate 1080. First substrate 1010 and second substrate 1080 may include materials that may be transparent to visible light, such as glass. Driver array 1020 may include an array of drive circuits for driving individual pixels. In one example, the array of drive circuits may include an array a thin-film transistor (TFT) pixel drive circuit. Alignment layers 1030 and 1032 may include, for example, polyimide (PI), and may have alignment patterns formed in the polyimide layer. Protective layer 1060 may be used to protect color filters 1070 and achieve a flat surface for interfacing with color filters 1070. In some examples, a transparent conductive material layer (e.g., an ITO) may be formed on a surface of protective layer 1060 to function as a common electrode. Driver array 1020 and protective layer 1060 may be separated by sub-spacers 1050 and photo spacers 1052 to define a cavity that can be filled with a liquid crystal material. Sub-spacers 1050 and photo spacers 1052 may be aligned so that a photo spacer 1052 may be positioned on a corresponding sub-spacer 1050 and the height of the cavity may be about the total height of a photo spacer 1052 and a sub-spacer 1050. As described above, color filters 1070 may include red, green, and blue filters to form color sub-pixels of the pixels of LCD panel 1000. Black matrix 1072 may be used to, for example, reduce light leakage between pixels, reduce external light reflection, and improve image contrast.

As illustrated in FIG. 10A, during the normal operation where photo spacers 1052 and sub-spacers 1050 are properly aligned, LC molecules around photo spacers 1052 and sub-spacers 1050 in liquid crystal layer 1040 may be well aligned by the alignment pattern formed in alignment layer 1030 and 1032. When display panel 1000 is illuminated by backlight passes, there may be no PS mura symptom when a dark image pattern is displayed.

FIG. 10B illustrates an example of a soft failure mode of LCD panel 1000 due to PS mura caused by shear stress. As illustrated, when a force is applied to LCD panel 1000, the force may cause deformation and shear stress between the color filter (CF) glass (e.g., second substrate 1080) and the thin-film transistor (TFT) glass (e.g., first substrate 1010). Polyimide at some PS/SS locations may be scratched or otherwise damaged, and thus the LC orientation at some PS/SS locations may be disturbed. As such, some backlight may pass through LCD panel 1000 to cause PS mura even if a dark image pattern is displayed. In some examples, the LC orientation may recover and the PS mura symptom in the soft failure mode may disappear after dwelling or after heating up LCD panel 1000.

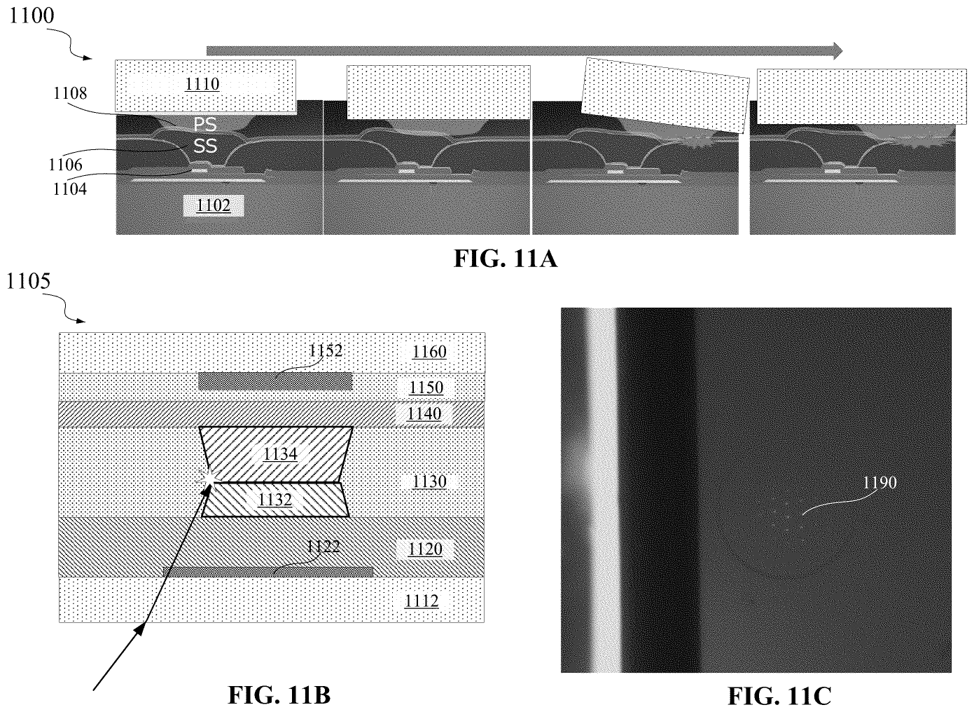

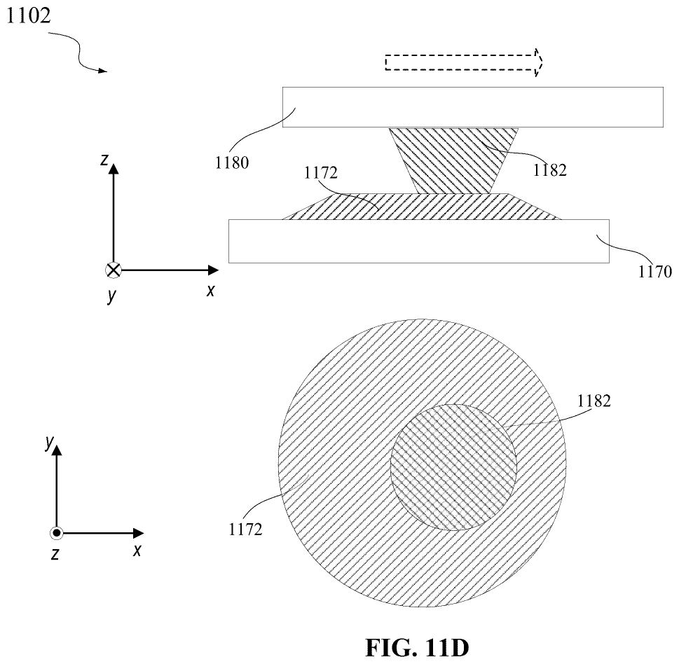

FIG. 11A illustrates an example of a hard failure mode of an LCD panel 1100 due to PS mura caused by shear stress. LCD panel 1100 may be an example of LCD panel 1000, and may include a first substrate 1102, an array of drive circuits 1104 formed in first substrate 1102, an array of sub-spacers 1106 aligned with the array of drive circuits 1104, an array of photo spacer 1108 aligned with the array of sub-spacers 11106, and a top structure 1110 that may include, for example, a protective layer, a transparent conductive layer, color filters, a black matrix, and a second substrate as described above. FIG. 11A shows that an external force applied to LCD panel 1100 may cause deformation of LCD panel 1110, which may cause sheer stress between fist substrate 1102 and top structure 1110. The sheer stress between fist substrate 1102 and top structure 1110 may cause photo spacer 1108 to slide with respect to sub-spacer 1106. When the force applied to LCD panel is sufficiently high, photo spacer 1108 may slide off sub-spacer 1106, causing permanent polyimide damages and permanent distortion to the LC orientation. Thus, the LC orientation distortion may not recover, and PS mura may not disappear in the hard failure mode.

FIG. 11B illustrates an example of light leakage due to PS mura. FIG. 11B shows an LCD panel 1105, which may be an example of LCD panel 1000. FIG. 11B shows a first substrate 1112, an array of drive circuits 1120 including light shields 1122, sub-spacers 1132, photo spacers 1134, a liquid crystal layer 1130, a protective layer 1140 (or a transparent conductive layer), color filters 1150 in a black matrix 1152, and a second substrate 1160. As illustrated, when the alignment layer (e.g., a polyimide layer) at a PS/SS location is scratched, or the LC orientation at the PS/SS location is otherwise disturbed, there may be light leakage at the location when a dark pattern is shown by the display.

FIG. 11C illustrates examples of bright dots caused by PS mura in an LCD panel. As illustrated, when a dark image pattern is to be displayed by the LCD panel, bright dots 1190 may appear due to the soft and/or hard PS mura. When bright dots 1190 are caused by soft mura, they may disappear after some dwelling time, after the LCD panel is thermally treated, or after the deformation force is removed. When bright dots 1190 are caused by hard mura, they may remain after the deformation force is removed and the LCD panel is thermally treated. It may be desirable to reduce or avoid both the soft mura and the hard mura.

According to certain embodiments, to improve PS mura margin and achieve a mechanically robust display, the lateral size of a light shield (e.g., light shield 1122) and a sub-spacer (e.g., sub-spacer 1132) of an LCD panel can be increased, and the lateral size of a photo spacer may be reduced, such that it is less likely that the photo spacer may slide off the corresponding sub-spacer. For example, the lateral size (or area) of the surface of the photo spacer that contacts the corresponding sub-spacer may be at least about 10%, about 20%, about 25%, about 30%, or about 50% smaller than the lateral size (or area) of the surface of the corresponding sub-spacer that contacts the photo spacer.

The fabrication process can be improved such that the surface of the PS and the surface of the SS that contact each other may be flat, and thus the photo spacer may be less likely to slide off the corresponding sub-spacer. In addition, the PS/SS height ratio can be adjusted (e.g., to have a lower SS height), and the thickness of the color filter glass (e.g., second substrate 1080 or 1160) and/or TFT glass (e.g., first substrate 1010 or 1112) can be adjusted, to improve the mechanical strength and stiffness of the LCD panel, thereby reducing the deformation of the LCD panel in response to external force, without significantly changing the thickness and weight of the LCD panel. For example, the height of the photo spacer may be at least about 10%, about 20%, about 25%, about 30%, or about 50% greater than the height of the corresponding sub-spacer. The total height of the photo spacer and the corresponding sub-spacer may be less than about 2 μm, such as less than about 1.9 μm, less than about 1.8 μm, or lower.

FIG. 11D illustrates an example of an LCD panel 1102 according to certain embodiments. In the illustrated example, LCD panel 1102 may include a first substrate 1170 including one or more sub-spacers 1172 formed thereon, and a second substrate 1180 including one or more photo spacers 1182 formed thereon. As illustrated, a sub-spacer 1172 may have a larger lateral size (or area) and a lower height than the photo spacer 1182 supported by sub-spacer 1172. In this way, even if there is a relative shift between photo spacer 1182 and the corresponding sub-spacer 1172, photo spacer 1182 may still be fully supported by the corresponding sub-spacer 1172. In addition, the total height of photo spacer 1182 and the corresponding sub-spacer 1172 may be lower than that shown in, for example; FIGS. 9A, 10A, and 11B. Furthermore, first substrate 1170 and second substrate 1180 may have higher thicknesses than the corresponding substrates shown in, for example; FIGS. 9A, 10A, and 11B, and thus LCD panel 1102 may have a lower deformation when a similar external force is applied to it, and may less likely to have photo spacer mura.

LCD displays may also suffer from the screen-door effect (SDE). The screen-door effect is a visual artifact of displays, where lines separating pixels/subpixels may become visible in the displayed images. In transmissive LCD displays, pixel drive circuits, bus lines, and other opaque structures may compete for space with the transmissive area where light can pass through (the pixel active area). As the pixel density increases, the pixel circuits may take more and more space, leaving smaller and smaller active areas, such that the SDE may become worse. In LCD displays for VR applications, the SDE may be more severe due to the high magnification of the display optics (e.g., lens).

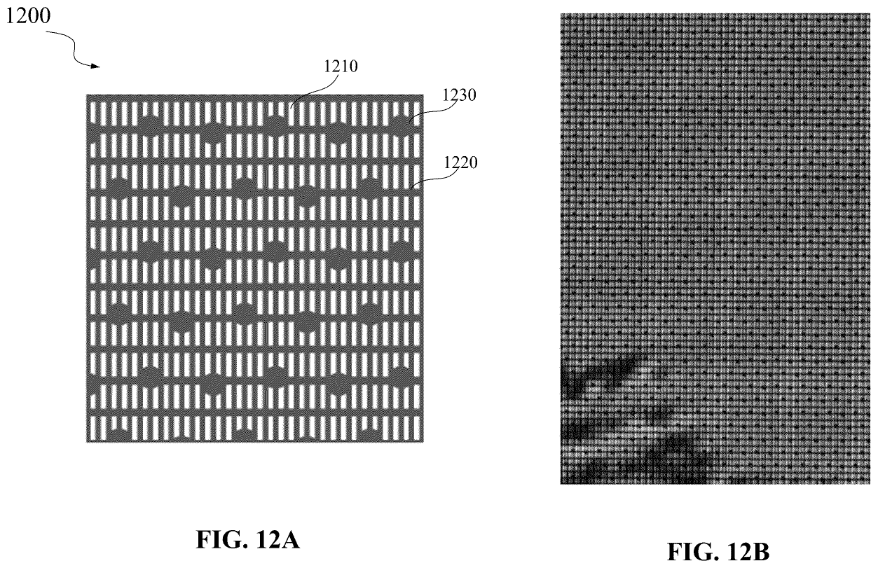

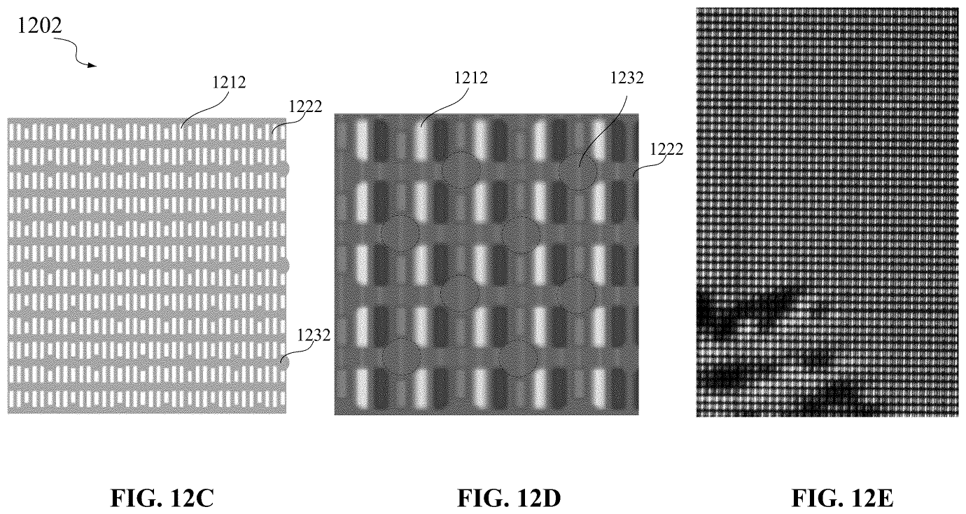

FIG. 12A illustrates an example of pixel design in an example of an LCD panel 1200. FIG. 12B includes an example of a microscopic image showing the screen-door effect (SDE) of LCD panel 1200 of FIG. 12A. As illustrated, LCD panel 1200 may include a two dimensional array of subpixels 1210. Subpixels 1210 may be separated by lines 1220, which may include column lines and row lines where pixel drive circuits and conductive traces may be formed. Spacers 1230 may be formed in some regions, such as some intersections of the column lines and row lines. In the illustrated example, fewer large spacers may be used, and the spacers may be near (or over at least a portion of) some blue subpixels and red subpixels. The aperture ratio of the blue subpixel may be a smaller percentage (ratio) of the aperture ratio of the red subpixels. The SDE may be more noticeable for red contents.

The SDE of the LCD panel may be mitigated by increasing the display resolution (e.g., PPI). However, the PPI of transmissive LCD panel may be limited due to the desired size of the active area of each subpixel. According to certain embodiments, in addition to increase the display resolution (e.g., PPI), the pixel/cell design may be improved to mitigate the SDE.

FIG. 12C illustrates an example of pixel design in an example of an LCD panel 1202 with reduced SDE. FIG. 12D illustrates an example of a photomask showing pixel design of LCD panel 1202 of FIG. 12C. FIG. 12E illustrates an example of a microscopic image showing the reduced screen-door effect of LCD panel 1202. LCD panel 1202 may include a two dimensional array of subpixels 1212. Subpixels 1212 may be separated by lines 1222, which may include column lines and row lines where pixel drive circuits and conductive traces may be formed. Spacers 1232 may be formed in some regions, such as some intersections of the column lines and row lines. In the illustrated example, each spacer 1232 may be smaller than a spacer 1230, but LCD panel 1202 may include more spacers than LCD panel 1200. Thus, the total area of the spacers in LCD panel 1202 may be similar to the total area of the spacers in LCD panel 1200. The spacers may be near (or over at least a portion of) the red sub pixels. In LCD panel 1202, the aperture ratio of the blue subpixel may be a higher percentage (ratio) of the aperture ratio of the red subpixels than in LCD panel 1200. The brightness of LCD panel 1202 may be slightly lower than the brightness of LCD panel 1200 due to, for example, the limited minimum size of the black mask in the black matrix, but the SDE may be significantly reduced in LCD panel 1210 compared with LCD panel 1200, as shown by FIG. 12E.

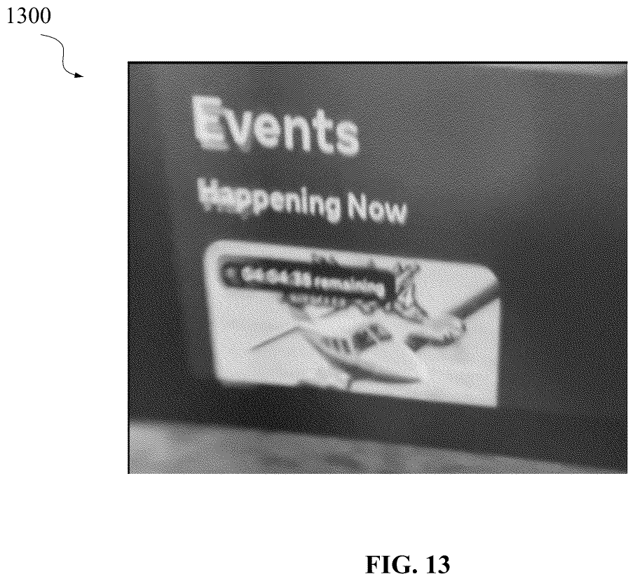

Display ghosting is a visually perceivable phenomenon that might appear as double images when users move their heads quickly or when users view fast-moving objects without head movements. Display ghosting may occur when the backlight unit is turned on while the liquid crystal is still settling and not fully switched due to long response time of the liquid crystal. Therefore, the display may not be able to refresh pixels fast enough to keep up with images in motion, causing the displayed image appeared to have a smeared ghosting image besides the original image. FIG. 13 illustrates an example of display ghosting in an LCD panel. As illustrated, portions of the displayed image may have a ghosting image besides the original image.

According to certain embodiments, the display ghosting may be reduced by using liquid crystal materials with low viscosity and high birefringence (such that a desired phase change can be achieved using a thinner liquid crystal layer) and reducing the cell gap (which may increase the electrical field with a similar control voltage applied across the LC cell) to improve the liquid crystal response time. For example, the liquid crystal material may have a lower viscosity (e.g., below a certain viscosity value), and/or a higher birefringence (e.g., greater than a certain birefringence value). The display ghosting may also be reduced by reducing display line scanning time, reducing the backlight unit emission period, delaying the backlight unit on time (e.g., at least partially into the line scanning time of the next frame), or a combination thereof, to allow more time for liquid crystal to settle during each frame. In some embodiments, the display ghosting may additionally or alternatively be reduced by, for example, increasing the Mobile Industry Processor Interface (MIPI) rate to reduce the display scanning time.

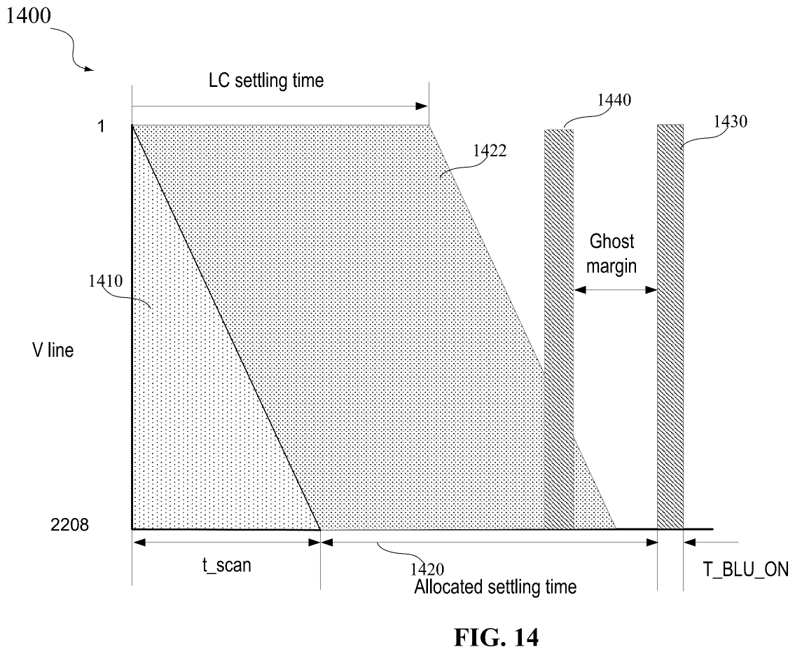

FIG. 14 illustrates an example of a timing diagram 1400 of an image frame of an LCD panel. As illustrated, the image frame may include panel scan time 1410, allocated LC settling time 1420, and BLU on period 1430. The display ghosting margin may be determined based on the difference between the allocated LC settling time 1420 and the actual LC settling time 1422. When the allocated LC settling time 1420 is shorter than the actual LC settling time 1422, the BLU may be turned on while the LC is still settling, thereby causing the ghost image. When the allocated LC settling time 1420 is longer than the LC settling time 1422, the BLU may be turned on after the LC is settled, and therefore no ghost image may be displayed.

As described above, the display ghosting may be reduced by reducing the response (settling) time of the liquid crystal and/or increasing the allocated LC settling time for the LC to settle. The allocated LC settling time may be increased by, for example, reducing the panel scan time, reducing the “on” time of the BLU (pulse width of the BLU light pulse), delaying the “on” time of the BLU out (e.g., at least partially overlapping with the panel scan time for the next image frame), or a combination thereof. The actual LC settling time may be reduced by, for example, reducing the cell gap, using liquid crystal materials with low viscosity and high birefringence (thus lower cell gap and lower response time), or a combination thereof. In some embodiments, the display ghosting may additionally or alternatively be reduced by increasing the MIPI rate, response time sorting, and the like.

In VR HMDs, color perception may significantly affect user experience because users may be immersed in a dark environment. The color performance of VR HMDs may depend on the display spectra and lens spectra. According to certain embodiments, the color gamut of an VR HMD may be improved by considering both the lens spectra and the display spectra, for example, by considering the lens spectra when designing the color filters and pixels.

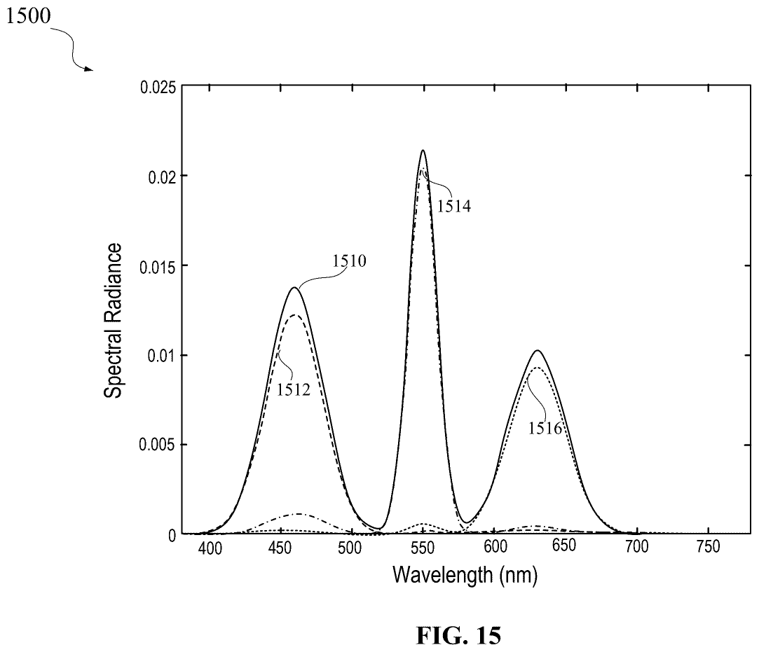

FIG. 15 includes a diagram 1500 illustrating an example of a radiance spectrum of an LCD panel of an HMD for VR applications. Curves 1512, 1514, and 1516 in FIG. 15 show the spectral radiance of red, green, and blue light, respectively. A curve 1510 shows the total radiance of the LCD panel. In most VR HMDs, the desired color gamut (e.g., SRGB) may be designed by tuning the color gamut of the LCD panel, such as tuning the display color filter and pixel design, without considering the spectral transmittance of the display optics (e.g., lenses).

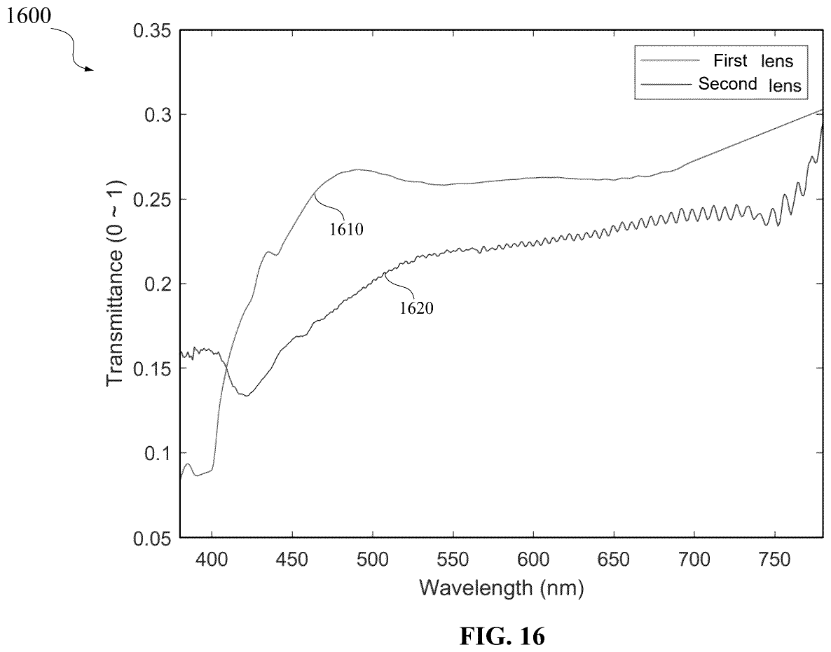

FIG. 16 includes a diagram 1600 illustrating examples of the spectral transmittance of display optics (e.g., lenses) of an VR HMD. In FIG. 16, a curve 1610 shows the transmittance of a first lens, whereas a curve 1620 shows the transmittance of a second lens. As illustrated, the display optics (e.g., lenses) may function as a color filter. As such, the color gamut (and spectral radiance) of the VR HMD may be different from the color gamut (and spectral radiance) of the LCD panel itself. In addition, different lenses may have different spectral transmittance, and thus may filter the color gamut of the LCD panel differently.

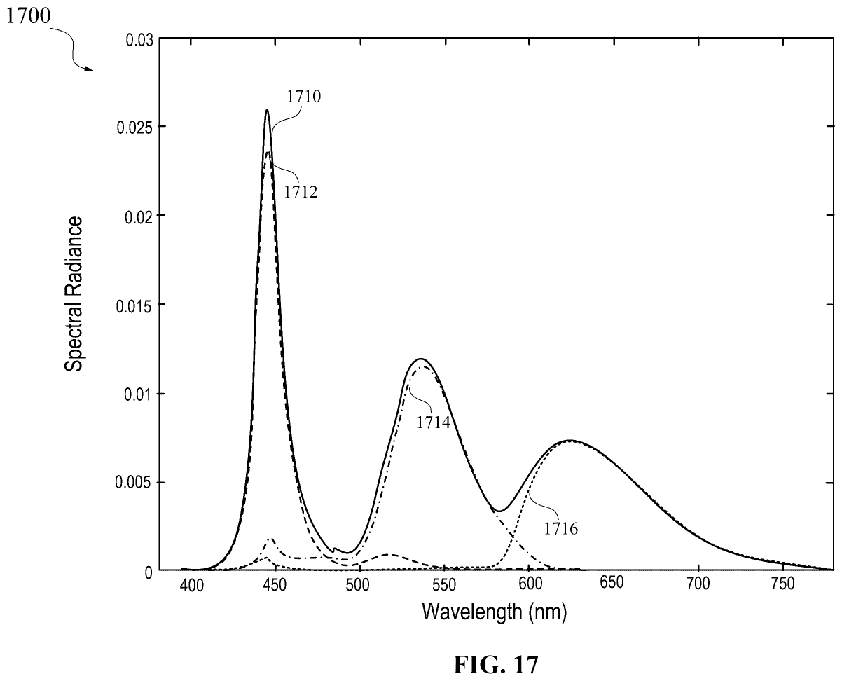

FIG. 17 includes a diagram 1700 illustrating an example of a radiance spectrum of an VR HMD. Curves 1712, 1714, and 1716 in FIG. 17 show the spectral radiance of red, green, and blue light, respectively, of the VR HMD. A curve 1710 shows the total radiance of the VR HMD. The total radiance spectrum of the VR HMD may be the product of the radiance spectrum of an LCD panel of the VR HMD (e.g., as shown in FIG. 15) and the spectral transmittance curve of the display optics (e.g., as shown in FIG. 16). To achieve the desired color gamut performance of an VR HMD, the radiance spectrum of the LCD panel of the VR HMD may be designed based on the spectral transmittance curve of the display optics.

Motion to photon latency (M2PL) is the lag between a user making a head movement and the movement being fully reflected on the display. Low M2PL can improve the immersive experience of the user (to make user feel that they are present in the virtual world). High M2PL may cause poor virtual reality experience, causing motion sickness and nausea. M2PL may be reduced by, for example, increasing motion sensor sampling rate, improving motion prediction accuracy, increasing display refresh rate, or a combination thereof. According to certain embodiments, the motion to photon latency for VR LCD display may be reduced using, for example, temperature dependent backlight timing (due to faster LC response at higher temperature), increased display MIPI rate, display scaling, or a combination thereof.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

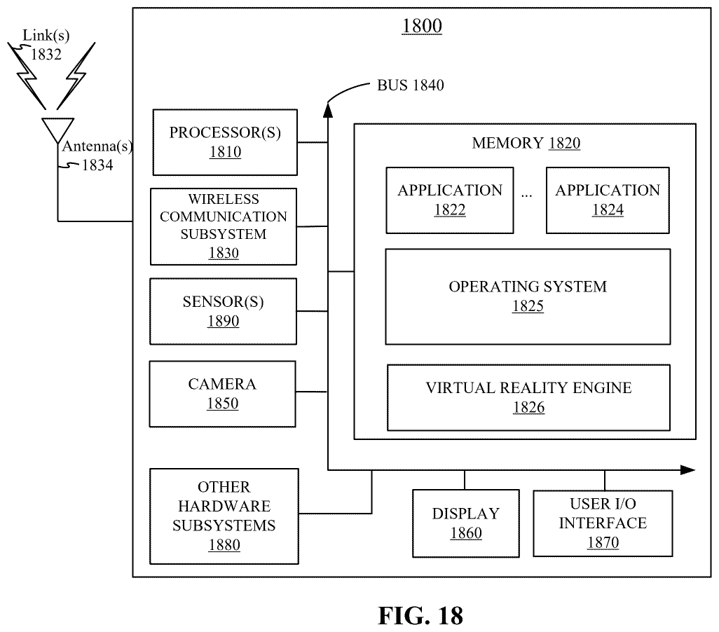

FIG. 18 is a simplified block diagram of an example of an electronic system 1800 of an example near-eye display (e.g., HMD device) for implementing some of the examples disclosed herein. Electronic system 1800 may be used as the electronic system of an HMD device or other near-eye displays described above. In this example, electronic system 1800 may include one or more processor(s) 1810 and a memory 1820. Processor(s) 1810 may be configured to execute instructions for performing operations at a number of components, and can be, for example, a general-purpose processor or microprocessor suitable for implementation within a portable electronic device. Processor(s) 1810 may be communicatively coupled with a plurality of components within electronic system 1800. To realize this communicative coupling, processor(s) 1810 may communicate with the other illustrated components across a bus 1840. Bus 1840 may be any subsystem adapted to transfer data within electronic system 1800. Bus 1840 may include a plurality of computer buses and additional circuitry to transfer data.

Memory 1820 may be coupled to processor(s) 1810. In some embodiments, memory 1820 may offer both short-term and long-term storage and may be divided into several units. Memory 1820 may be volatile, such as static random access memory (SRAM) and/or dynamic random access memory (DRAM) and/or non-volatile, such as read-only memory (ROM), flash memory, and the like. Furthermore, memory 1820 may include removable storage devices, such as secure digital (SD) cards. Memory 1820 may provide storage of computer-readable instructions, data structures, program code, and other data for electronic system 1800. In some embodiments, memory 1820 may be distributed into different hardware subsystems. A set of instructions and/or code might be stored on memory 1820. The instructions might take the form of executable code that may be executable by electronic system 1800, and/or might take the form of source and/or installable code, which, upon compilation and/or installation on electronic system 1800 (e.g., using any of a variety of generally available compilers, installation programs, compression utilizes, decompression utilities, etc.), may take the form of executable code.

In some embodiments, memory 1820 may store a plurality of applications 1822 through 1824, which may include any number of applications. Examples of applications may include gaming applications, conferencing applications, video playback applications, or other suitable applications. The applications may include a depth sensing function or eye tracking function. Applications 1822-1824 may include particular instructions to be executed by processor(s) 1810. In some embodiments, certain applications or parts of applications 1822-1824 may be executable by other hardware subsystems 1880. In certain embodiments, memory 1820 may additionally include secure memory, which may include additional security controls to prevent copying or other unauthorized access to secure information.

In some embodiments, memory 1820 may include an operating system 1825 loaded therein. Operating system 1825 may be operable to initiate the execution of the instructions provided by applications 1822-1824 and/or manage other hardware subsystems 1880 as well as interfaces with a wireless communication subsystem 1830 which may include one or more wireless transceivers. Operating system 1825 may be adapted to perform other operations across the components of electronic system 1800 including threading, resource management, data storage control and other similar functionality.

Wireless communication subsystem 1830 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1800 may include one or more antennas 1834 for wireless communication as part of wireless communication subsystem 1830 or as a separate component coupled to any portion of the system. Depending on desired functionality, wireless communication subsystem 1830 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1830 may permit data to be exchanged with a network, other computer systems, and/or any other devices described herein. Wireless communication subsystem 1830 may include a means for transmitting or receiving data, such as identifiers of HMD devices, position data, a geographic map, a heat map, photos, or videos, using antenna(s) 1834 and wireless link(s) 1832.

Embodiments of electronic system 1800 may also include one or more sensors 1890. Sensor(s) 1890 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1890 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1800 may include a display 1860. Display 1860 may be a near-eye display, and may graphically present information, such as images, videos, and various instructions, from electronic system 1800 to a user. Such information may be derived from one or more applications 1822-1824, virtual reality engine 1826, one or more other hardware subsystems 1880, a combination thereof, or any other suitable means for resolving graphical content for the user (e.g., by operating system 1825). Display 1860 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1800 may include a user input/output interface 1870. User input/output interface 1870 may allow a user to send action requests to electronic system 1800. An action request may be a request to perform a particular action. For example, an action request may be to start or end an application or to perform a particular action within the application. User input/output interface 1870 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1800. In some embodiments, user input/output interface 1870 may provide haptic feedback to the user in accordance with instructions received from electronic system 1800. For example, the haptic feedback may be provided when an action request is received or has been performed.

Electronic system 1800 may include a camera 1850 that may be used to take photos or videos of a user, for example, for tracking the user's eye position. Camera 1850 may also be used to take photos or videos of the environment, for example, for VR, AR, or MR applications. Camera 1850 may include, for example, a complementary metal-oxide-semiconductor (CMOS) image sensor with a few millions or tens of millions of pixels. In some implementations, camera 1850 may include two or more cameras that may be used to capture 3-D images.

In some embodiments, electronic system 1800 may include a plurality of other hardware subsystems 1880. Each of other hardware subsystems 1880 may be a physical subsystem within electronic system 1800. While each of other hardware subsystems 1880 may be permanently configured as a structure, some of other hardware subsystems 1880 may be temporarily configured to perform specific functions or temporarily activated. Examples of other hardware subsystems 1880 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1880 may be implemented in software.

In some embodiments, memory 1820 of electronic system 1800 may also store a virtual reality engine 1826. Virtual reality engine 1826 may execute applications within electronic system 1800 and receive position information, acceleration information, velocity information, predicted future positions, or some combination thereof of the HMD device from the various sensors. In some embodiments, the information received by virtual reality engine 1826 may be used for producing a signal (e.g., display instructions) to display 1860. For example, if the received information indicates that the user has looked to the left, virtual reality engine 1826 may generate content for the HMD device that mirrors the user's movement in a virtual environment. Additionally, virtual reality engine 1826 may perform an action within an application in response to an action request received from user input/output interface 1870 and provide feedback to the user. The provided feedback may be visual, audible, or haptic feedback. In some implementations, processor(s) 1810 may include one or more GPUs that may execute virtual reality engine 1826.

In various implementations, the above-described hardware and subsystems may be implemented on a single device or on multiple devices that can communicate with one another using wired or wireless connections. For example, in some implementations, some components or subsystems, such as GPUs, virtual reality engine 1826, and applications (e.g., tracking application), may be implemented on a console separate from the head-mounted display device. In some implementations, one console may be connected to or support more than one HMD.

In alternative configurations, different and/or additional components may be included in electronic system 1800. Similarly, functionality of one or more of the components can be distributed among the components in a manner different from the manner described above. For example, in some embodiments, electronic system 1800 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

In this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A near-eye display including:
a liquid crystal display (LCD) comprising:
a first substrate;
a second substrate;
a plurality of photo spacers formed on the second substrate;
a plurality of sub-spacers formed on the first substrate, each sub-spacer of the plurality of sub-spacers configured to support a corresponding photo spacer of the plurality of photo spacers; and
a liquid crystal material in regions between the first substrate and the second substrate,
wherein a resolution of the LCD is greater than 800 pixels per inch.

2. The near-eye display of claim 1, wherein a lateral size of each photo spacer of the plurality of photo spacers is smaller than a lateral size of a corresponding sub-spacer of the plurality of photo spacers.

3. The near-eye display of claim 2, wherein the lateral size of each photo spacer of the plurality of photo spacers is at least 25% smaller than the lateral size of the corresponding sub-spacer of the plurality of photo spacers.

4. The near-eye display of claim 1, wherein a height of each photo spacer of the plurality of photo spacers is larger than a height of a corresponding sub-spacer of the plurality of photo spacers.

5. The near-eye display of claim 4, wherein the height of each photo spacer of the plurality of photo spacers is at least 25% larger than the height of the corresponding sub-spacer of the plurality of photo spacers.

6. The near-eye display of claim 1, wherein:
each photo spacer of the plurality of photo spacers has a flat surface that contacts a corresponding sub-spacer of the plurality of sub-spacers; and
the corresponding sub-spacer has a flat surface that contacts the photo spacer.

7. The near-eye display of claim 1, wherein a distance between the first substrate and the second substrate is less than 2 μm.

8. The near-eye display of claim 1, wherein the resolution of the LCD is greater than 1200 pixels per inch.

9. The near-eye display of claim 1, further comprising display optics configured to project images displayed by the LCD to a user's eye.

10. The near-eye display of claim 9, wherein a spectral radiance of the LCD is selected based on a spectral transmittance curve of the display optics to achieve a target color gamut for the near-eye display.

11. The near-eye display of claim 1, wherein the liquid crystal material is characterized by a viscosity below a viscosity value, a birefringence greater than a birefringence value, or both.

12. A liquid crystal display (LCD) comprising:
a first substrate;
a second substrate;
a plurality of photo spacers formed on the second substrate;
a plurality of sub-spacers formed on the first substrate, each sub-spacer of the plurality of sub-spacers configured to support a corresponding photo spacer of the plurality of photo spacers; and
a liquid crystal material in regions between the first substrate and the second substrate,
wherein a resolution of the LCD is greater than 800 pixels per inch.

13. The LCD of claim 12, wherein a lateral size of each photo spacer of the plurality of photo spacers is smaller than a lateral size of a corresponding sub-spacer of the plurality of photo spacers.

14. The LCD of claim 13, wherein the lateral size of each photo spacer of the plurality of photo spacers is at least 25% smaller than the lateral size of the corresponding sub-spacer of the plurality of photo spacers.

15. The LCD of claim 12, wherein a height of each photo spacer of the plurality of photo spacers is larger than a height of a corresponding sub-spacer of the plurality of photo spacers.

16. The LCD of claim 15, wherein the height of each photo spacer of the plurality of photo spacers is at least 25% larger than the height of the corresponding sub-spacer of the plurality of photo spacers.

17. The LCD of claim 12, wherein:
each photo spacer of the plurality of photo spacers has a flat surface that contacts a corresponding sub-spacer of the plurality of sub-spacers; and
the corresponding sub-spacer has a flat surface that contacts the photo spacer.

18. The LCD of claim 12, wherein a distance between the first substrate and the second substrate is less than 2 μm.

19. The LCD of claim 12, wherein the resolution of the LCD is greater than 1200 pixels per inch.

20. The LCD of claim 12, wherein a spectral radiance of the LCD is selected based on a spectral transmittance curve of display optics of a near-eye display to achieve a target color gamut for the near-eye display.
